(19) United States
(12) Patent Application Publication
(10) Pub. No.: US 2004/0088429 A1
(43) Pub. Date: May 6, 2004

(54) Constrained path algoritm for transmission network

(76) Inventor: Xianlong Luo, Shenzhen (CN)

Correspondence Address: HARNESS, DICKEY & PIERCE, P.L.C., P.O. BOX 828, BLOOMFIELD HILLS, MI, 48303, US

(21) Appl. No.: 10/696,325

(22) Filed: Oct. 29, 2003

(30) Foreign Application Priority Data
Nov. 2, 2002 (CN) 02150111.4

(51) Int. Cl. G06F 15/16

(52) U.S. Cl. 709/232

(57) ABSTRACT

The invention discloses a method for calculating constrained paths for a transmission network. The method has the capability of automatic calculation of the shortest paths satisfying the SDH/SONET protection requirement, and can effectively reduce repeat computation times. The method comprises the steps of: collecting attribute information of the link to which each node is connected and obtaining the number of the protect entity to which the link belongs; flooding the collected information to other nodes according to a protocol; combining each node according to the numbers of the protection entities to which each link respectively belongs and forming the topology structure of each protection entity of whole network and related link attribute information; and calculating constrained paths for the transmission network. Since the protection topology is pre-calculated in this method, the repeat computation times can be effectively reduced and the constrained paths can be calculated in real time.

### CROSS-REFERENCE TO RELATED APPLICATIONS

This application claims the benefit of Chinese Patent Application No. 02150111.4, filed Nov. 2, 2002. The disclosure of the above application is incorporated herein by reference.

### FIELD OF THE INVENTION

The invention relates to a method for calculating constrained paths for a transmission network, particularly to a method for calculating constrained paths for a transmission network based on the SDH (Synchronous Digital Hierarchy)/SONET (Synchronous Optical NET) protection.

### BACKGROUND OF THE INVENTION

The prior transmission networks are mainly based on the SDH/SONET standards. In practical operation, a terminal-to-terminal service configuration is manually performed according to user requirements. In order to increase operability of transmission network, an automatic transmission network technology supporting automatic terminal-to-terminal service configuration has been proposed. The most familiar technical scheme with the present invention is CSPF (Constrained Shortest Path First) algorithm in traffic engineering field throughout the world. The basic idea of the CSPF algorithm is that a terminal-to-terminal optimized path is calculated through constrained-based shortest path algorithm. The main concerned constraints are bandwidth, administrative group and inhibited nodes etc.

The CSPF algorithm applies two databases: PATHS and TENT. Among them, the PATHS stores the information of the shortest path tree while the TENT stores information of tentative nodes which have been attempted before finding the shorted path. The information of the node is added to the PATHS database only when the shorted path to a node has been found.

In detail, the CSPF algorithm has the steps as follows.

1) Put a node doing the calculation on PATHS (no shorter path to itself can possibly exist), and TENT is pre-loaded from the local adjacency database.

2) When putting the node on PATHS, examine links from the node to each of its neighbor nodes. If a neighbor node is already in PATHS, this new way will be longer and thus ignored. If a neighbor node is in TENT and the new path is shorter, the old path is replaced with the new one. If the new path is the same length as the one in TENT, then the neighbor node has an equivalent path. If a neighbor node is not in TENT, then links and nodes that do not satisfy the Label Switching Path (LSP) constraint conditions are deleted and nodes respectively corresponding to links which satisfy the LSP constraint conditions are put on TENT.

3) Put the nodes with least-cost from TENT to PATHS.

4) When TENT is empty or the node with least-cost in TENT is a destination node, then the routing calculation is completed and the calculation result is outputted, otherwise the process will be jumped to Step 2).

The main disadvantage of the above prior art is that since it is based on mesh network design without considering the inherent protection mechanism of the transmission network, the shortest path satisfying the SDH/SONET protection requirement cannot be obtained through the path calculation method according to the prior art.

Therefore, it is necessary to provide a method for calculating optimized constrained terminal-to-terminal service path for a transmission network. In order to provide automatic service configuration capability in transmission network, the intelligent optical network devices must have the capability of automatic calculation of optimized terminal-to-terminal service path. Meanwhile, the original transmission networks have perfect protection capability, for example, they have provided the protection capability of multiplex section protection based on automatic protection switching protocol, so it is necessary for the intelligent optical network devices to be compatible with the original protection capability of transmission network.

### SUMMARY OF THE INVENTION

An object of the invention is to provide a method for calculating constrained paths based on the SDH/SONET protection for a transmission network. The method has the capability of automatic calculation of the shortest path satisfying SDH/SONET protection based on the protection type of transmission network and can thus effectively reduce repetition computation times.

In order to achieve this object, a method for calculating constrained paths comprises the following steps: collecting attribute information of the link to which each node is connected and obtaining the information of the protect entity to which the link belongs; flooding the collected information to other nodes according to a protocol; combining each node according to the numbers of the protection entities to which each link respectively belongs and forming the topology structure of each protection entity of whole network and related link attribute information; and calculating constrained paths for the transmission network.

In this method, Step a further comprises the step of obtaining the usable bandwidth of link, the protection capability of link, the local interface IP address and the remote interface IP address of link.

In this method, collecting attribute information of the link to which each node is connected in Step a further comprises the step of interrogating the user configuration information of optical network devices through a specific software interface.

In this method, the protocol in Step b is the Open Shortest Path First (OSPF) protocol.

In this method, flooding the collected information to other nodes according to a protocol in Step b is through the packets of Link State Advertisement (LSA).

In this method, Step d comprises:

d1. establishing PATHS for storing the information of the shortest path tree and TENT for storing the information of tentative nodes which have been attempted before finding the shorted path;

d2. putting the node doing the calculation on PATHS, and pre-loading TENT from the local adjacency database;

d3. when putting the node on PATHS, examining links from the node to each of its neighbor nodes, if a neighbor node is already in PATHS, then ignoring this new way because it is longer; if a neighbor node is in TENT and the new path is shorter, replacing the old path with the new one; if the new path is the same length as the one in TENT, then the neighbor node having an equivalent path; if a neighbor node is not in TENT, then deleting links and nodes that do not satisfy the LSP constraint conditions and putting nodes respectively corresponding to links which satisfy the LSP constraint conditions on TENT;

d4. putting the nodes with least-cost from TENT to PATHS; and

d5. ending the routing calculating until TENT is empty or the destination node is already existed in PATHS.

This method may further comprise the steps of:

d6. selecting the most appropriate path according to a policy if equal-cost paths exist;

d7. allocating a congruent time-slot to all nodes on this multiplex section protection (MSP) ring if the service passes a MSP ring; and

d8. if it is necessary to output protection paths simultaneously, outputting the protection paths based on the SDH/SONET protection topology according to the features of protection ring.

In this method, Step d3 further comprises: if the protection of 1:1 type is required, calculating the protection path based on the MSP protection ring or MSP protection link, wherein the nodes which can be put on TENT may be the nodes on the MSP protection ring or MSP protection link; and when passing through the protection ring, putting all the nodes that satisfy service constraint condition and protection requirement on the protection ring on TENT.

In summary, the invention has the following advantages: the shortest constrained path satisfying the constraint conditions can be calculated based on the protection type of transmission network; since a protection topology is pre-calculated, the repeat calculating times can be reduced and the constrained paths can be calculated in real time.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating the constrained path algorithm for a transmission network according to the present invention.

FIG. 2 is a schematic diagram illustrating a flooding procedure according to the present invention.

### DETAILED DESCRIPTION OF THE PREFERRED EMBODIMENTS

The following description of the preferred embodiment(s) is merely exemplary in nature and is in no way intended to limit the invention, its application, or uses.

The technical scheme according to the invention mainly includes two parts: the distributing and combining of topology information of protected entities, and constrained path calculating based on the SDH/SONET protection topology.

The distributing of topology information of the protected entities is implemented through the flooding procedure in OSPF protocol which is an interior gateway protocol. Particularly, protected entity information, such as the information of the protection ring to which a certain link belongs, is stored in a LSA and flooded as link attribute of the link. The procedure of flooding satisfies the requirements of Request for Comments (RFC) 2328. After the network node has obtained the link attribute information of the whole network, all nodes are combined according to the numbers of the protected entities to which each link respectively belongs; and a topology of protected entities of whole network is formed and related link attribute information is obtained. Here, the topology is represented by a linked-list based on the interconnection relationship between nodes.

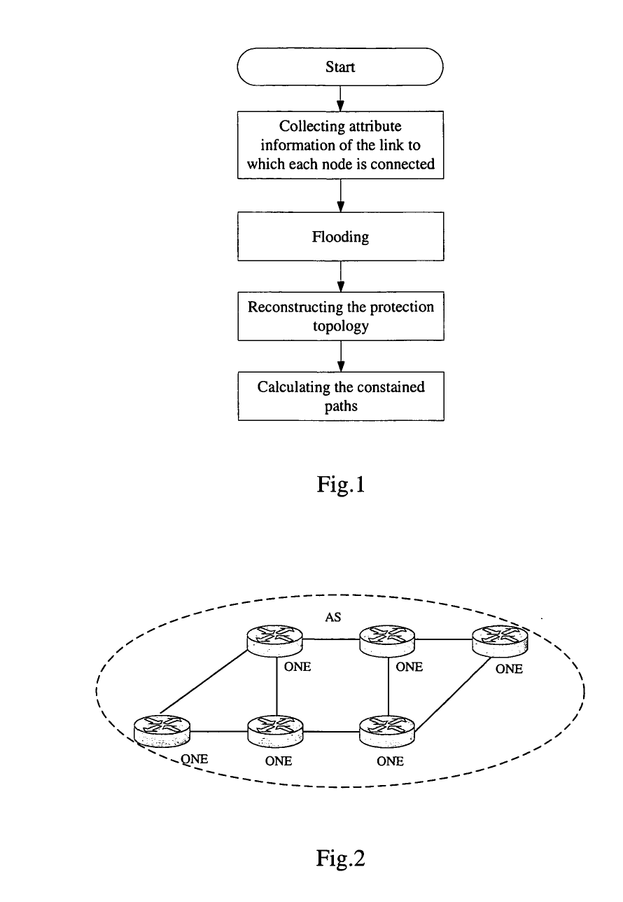

As shown in FIG. 1, a complete constrained path calculation procedure includes the following four steps.

First, link attribute information directly corresponding to the node information is collected. The link attribute information includes link bandwidth, protection capability of link, the local interface IP address and the remote interface IP address. Specially, the protection entity number of MSP to which the link belongs, i.e. the Identifier (ID) of protection group, is one of the most important link attribute information needing collecting. The specific processing of collecting is to interrogate user configuration information of the optical network devices through a specific software interface.

Secondly, the flooding procedure is implemented strictly according to the OSPF protocol, which is in detail described in the Chapter 13 of RFC2328 proposed by Internet Engineering Tasking Force (IETF). In short, the flooding procedure is a procedure that distributes the collected information called Link State Advertisement (LSA) to other nodes.

Next, as shown in FIG. 2, any Optical Network Element (ONE) in network can obtain protection group information of all network links through the flooding procedure. The protected entity information, such as the information of the protection ring to which a certain link belongs, is stored in a LSA and flooded as link attribute of the link. Therefore, after flooding is completed, each node of the network can obtain all link attribute information of the whole network. Then, all nodes are combined according to the numbers of the protected entities to which each link respectively belongs; and a topology of protected entities of whole network is formed and related link attribute information is obtained. The topology is represented by a linked-list based on the connection relationship between nodes.

Lastly, after the protection topology has been combined, a constrained path calculation processing can be done based on the SDH protection. In detail, the algorithm is performed as follows.

The PATHS stores the information of the shortest path tree while the TENT stores information of tentative nodes which have been attempted before finding the shorted path. The TENT is a sorted set and the base of its sort is cost value.

1) Put a node doing the calculation on PATHS (no shorter path to itself can possibly exist), and TENT is pre-loaded from the local adjacency database.

2) When putting the node on PATHS, examine links from the node to each of its neighbor nodes. If a neighbor node is already in PATHS, this new way will be longer and thus ignored. If a neighbor node is in TENT and the new path is shorter, the old path is replaced with the new one. If the new path is the same length as the one in TENT, then the neighbor node has an equivalent path. If a neighbor node is not in TENT, then links and nodes that do not satisfy the LSP constraint conditions are deleted and nodes respectively corresponding to links which satisfy the LSP constraint conditions are put on TENT. If the protection of 1:1 type is required, it is necessary to calculate the protection path based on the MSP protection ring or MSP protection link. In this case, the nodes which can be put on TENT may be those on the MSP protection ring or MSP protection link. Furthermore, when passing through the protection ring, other nodes satisfying service constraint conditions and protection requirements on the protection ring are put on TENT.

3) Put the nodes with least-cost from TENT to PATHS.

4) When TENT is empty or the destination node is already existed in PATHS, then the routing calculation is completed.

5) If there are equal-cost paths, then the most appropriate path is selected based on a certain policy; if there are several equal-cost paths to the same destination, one appropriate path needs to be selected as output of the calculation. At present, there are three selection policies: random selection, maximum remaining bandwidth rate of path first and minimum remaining bandwidth rate of path first.

6) If the service passes a MSP ring, then all nodes on this MSP ring must be allocated a congruent time-slot. This is because if there is a node failure, an automatic failure recovery can only be implemented when the time-slots of nodes on the MSP ring are unique; so the calculated path needs to satisfy the requirement. All time-slots for all nodes on the ring from the input node to the output node are examined and the congruent time-slot is selected. If no congruent time-slot can be selected, the path cannot be used.

7) When protection paths need to be output at one time, the protection paths based on the SDH/SONET protection topology are outputted according to the features of protection rings. At present, the outputting of protection path mainly aims at MSP protection ring. When the working path has been calculated, if more information of the protection path needs to be known, the protection path can be outputted according to the protection ring that the working path passed. In initial situation, the protection path of a MSP protection ring is the other half ring without covering by the working path.

The foregoing embodiment is merely exemplary and is not to be construed as limiting the present invention. The description of the present invention is intended to be illustrative, and not to limit the scope of the claims. Many alternatives, modifications, and variations will be apparent to those skilled in the art.

What is claimed is:

1. A method for calculating constrained paths for a transmission network, comprising:
a. respectively collecting attribute information of the link to which each node is connected and obtaining the information of the protect entity to which the link belongs;
b. flooding the collected attribute information to other nodes according to a protocol;
c. combining each node according to the information of the protection entities to which each link respectively belongs and forming the topology structure of each protection entity of whole network and related link attribute information; and
d. calculating constrained paths for the transmission network.

2. The method of claim 1, Step a further comprising the step of obtaining the usable bandwidth of link, the protection capability of link, the local interface IP address and the remote interface IP address of link.

3. The method of claim 2, collecting attribute information of the link to which each node is connected in Step a further comprising the step of interrogating the user configuration information of optical network devices through a specific software interface.

4. The method of claim 1, collecting attribute information of the link to which each node is connected in Step a further comprising the step of interrogating the user configuration information of optical network devices through a specific software interface.

5. The method of claim 1, wherein said protocol in Step b is the Open Shortest Path First (OSPF) protocol.

6. The method of claim 1, wherein flooding the collected attribute information to other nodes according to a protocol in Step b is through the packets of Link State Advertisement (LSA).

7. The method of claim 1, wherein Step d comprises:
d1. establishing PATHS for storing the information of the shortest path tree and TENT for storing the information of tentative nodes which have been attempted before finding the shorted path;
d2. putting the node doing the calculation on PATHS, and pre-loading TENT from the local adjacency database;
d3. examining links from the node to each of its neighbor nodes when putting the node on PATHS, if a neighbor node is already in PATHS, then ignoring this new way because it is longer; if a neighbor node is in TENT and the new path is shorter, replacing the old path with the new one; if the new path is the same length as the one in TENT, then the neighbor node having an equivalent path; if a neighbor node is not in TENT, then deleting links and nodes that do not satisfy the LSP constraint conditions and putting nodes respectively corresponding to links which satisfy the LSP constraint conditions on TENT;
d4. putting the nodes with least-cost from TENT to PATHS; and
d5. ending the routing calculating until TENT is empty or the destination node is already existed in PATHS.

8. The method of claim 7, further comprising the steps of:
d6. selecting the most appropriate path according to a policy if equal-cost paths exist;
d7. allocating a congruent time-slot to all nodes on this multiplex section protection (MSP) ring if the service passes a MSP ring; and
d8. if it is necessary to output protection paths simultaneously, outputting the protection paths based on the SDH/SONET protection topology according to the features of protection ring.

9. The method of claim 7, Step d3 further comprising:
if the protection of 1:1 type is required, calculating the protection path based on the MSP protection ring or MSP protection link, wherein the nodes which can be put on TENT may be the nodes on the MSP protection ring or MSP protection link; and
when passing through the protection ring, putting all the nodes that satisfy service constraint conditions and protection requirements on the protection ring on TENT.
